(19) United States
(12) Patent Application Publication
(10) Pub. No.: US 2010/0271967 A1
(43) Pub. Date: Oct. 28, 2010

(54) METHOD AND APPARATUS FOR MEASURING DEMODULATING PERFORMANCE OF COMMUNICATION SYSTEM

(75) Inventors: Keun-Pyo Hong, Daejon (KR); Hokyom Kim, Daejon (KR); Dae-Ig Chang, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejon (KR)

(21) Appl. No.: 12/747,592

(22) PCT Filed: Aug. 5, 2008
(86) PCT No.: PCT/KR2008/004549

§ 371 Date: Jun. 11, 2010

(30) Foreign Application Priority Data
Dec. 11, 2007 (KR) 10-2007-0128378
Feb. 19, 2008 (KR) 10-2008-0014783

(51) Int. Cl. H04J 1/16

(52) U.S. Cl. 370/252

(57) ABSTRACT

Provided is a method and apparatus for measuring demodulating performance of a communication system. The method includes: commanding the mobile station to modulate test pattern data and transmit test pattern data to the central station; commanding the central station to comparing a demodulation result of the data transmitted from the mobile station with the test pattern data; and receiving the comparison result from the central station.

### TECHNICAL FIELD

The present invention relates to a method and apparatus for measuring demodulating performance of a communication system; and, more particularly, to a method and apparatus for measuring demodulating performance of a central station at a system level in a normal operation state that a link is connected between a mobile station and the central station of a communication system.

This work was supported by the IT R&D program for MIC/IITA [2007-S-301, “Development of Satellite Communications System for Communications, Ocean and Meteorological Satellite”].

### BACKGROUND ART

In a communication system, the demodulating performance of the system is an important index for evaluating the system. The demodulating performance is affected by an error correction code and is predictable at a time for designing an error correction code. However, it is difficult to evaluate the system performance based on only demodulator performance since realization margin or other modules related to the demodulator may affect the performance.

That is, in a conventional method for measuring performance and quality of the communication system, performance and quality are measured only through operation check of the demodulator itself in a state that other modules are not connected. Also, performance and quality are not measured in a state that the mobile station and the central station are connected through a link or that an entire system including modules is in operation.

### DISCLOSURE OF INVENTION

### Technical Problem

An embodiment of the present invention is directed to providing a method and apparatus for measuring demodulating performance in a state that an entire communication system normally operates.

The objects of the present invention are not limited to the above-mentioned ones. However, other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for measuring demodulating performance in a communication system of a state that a link is connected between a mobile station having a modulator and a central station having a demodulator, including: commanding the mobile station to modulate test pattern data and transmit test pattern data to the central station; commanding the central station to comparing a demodulation result of the data transmitted from the mobile station with the test pattern data; and receiving the comparison result from the central station.

In accordance with another aspect of the present invention, there is provided an apparatus for measuring demodulating performance in a communication system of a state that a link is connected between a mobile station having a modulator and a central station having a demodulator, including: a communication unit for communicating with the mobile station and the central station; and a control unit for controlling the mobile station to modulate and transmit test pattern data to the central station, controlling the central station to compare a demodulation result of the data transmitted from the mobile station with the test pattern data, and controlling the communication unit to receive the comparison result from the central station.

In accordance with another aspect of the present invention, there is provided a computer readable recording medium for recording a program for performing a method of measuring demodulating performance in a communication system in a state that a link is connected between a mobile station having a modulator and a central station having a demodulator, the program, including: commanding the mobile station to modulate and transmit test pattern data to the central station; and commanding the central station to compare the demodulation result of the data transmitted from the mobile station with the test pattern data.

### ADVANTAGEOUS EFFECTS

As described above, the present invention can exactly measure demodulating performance of a central station in a state that an entire system normally operates by connecting a mobile station and the central station through a link. Also, the present invention is applicable to any communication system supporting an Internet protocol and can perform measurement with no regard to the location of the mobile station or the central station. There is a benefit that the present invention can grasp test performance command, traffic burst set-up control, and a statistic measurement result in the measuring apparatus or program at a look.

### BRIEF DESCRIPTION OF THE DRAWINGS

FIG. 1 is a block diagram showing a system of a demodulating performance measuring apparatus in accordance with an embodiment of the present invention.

FIG. 2 is a block diagram showing a demodulating performance measuring system in accordance with an embodiment of the present invention.

FIG. 3 is a flowchart describing a demodulating performance measuring method in accordance with an embodiment of the present invention.

FIG. 4 is a flowchart describing a demodulating performance measuring operation in accordance with an embodiment of the present invention.

FIG. 5 shows an output screen of the demodulating performance measuring apparatus in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

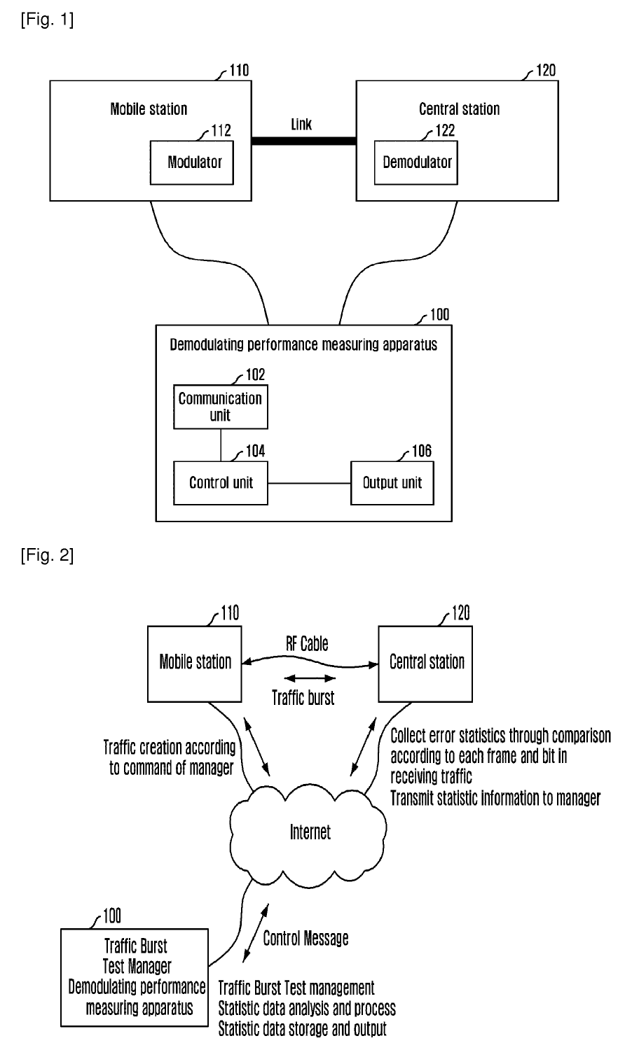

FIG. 1 is a block diagram showing a system of a demodulating performance measuring apparatus in accordance with an embodiment of the present invention.

A demodulating performance measuring apparatus 100 includes a communication unit 102 and a control unit 104. An output unit 106 may be additionally included.

A link is connected between a mobile station 110 and a central station 120 directly or through a satellite in a satellite communication system or through a base station in a mobile communication system.

The communication unit 102 controls that the demodulating performance measuring apparatus 100 transmits/receives a command, data and a signal with the mobile station 110 and the central station 120.

The control unit 104 controls that the mobile station 110 modulates and transmits test pattern data to the central station 120 and the central station 120 compares a demodulation result of the data transmitted from the mobile station 110 with the test pattern data. Also, the control unit 104 controls that the communication unit 102 receives the comparison result from the central station 120. The control unit 104 controls general matters required for operating the demodulating performance measuring apparatus 100.

The demodulating performance is measured based on bit error rate (BER) and frame error rate (FER). In order to measure the demodulating performance in a state that a link is connected, the demodulating performance measuring apparatus 100 controls that the mobile station 110 modulates test pattern data in a modulator 112 and transmits the test pattern data to the central station 120. The central station 120 demodulates the transmitted data in a demodulator 122 and compares the data with own test pattern data or the original test pattern data transmitted from the demodulating performance measuring apparatus 100. Data comparison is performed on the basis of a bit or frame unit to thereby output a bit error rate and a frame error rate.

When the compared statistic result is transmitted to the demodulating performance measuring apparatus 100, the demodulating performance measuring apparatus 100 outputs the bit error rate or the frame error rate through the comparison data. The demodulating performance measuring apparatus 100 does not directly output the bit error rate or the frame error rate. However, the central station 120 receives the outputted result of the bit error rate or the frame error rate directly from a comparison statistic result. Subsequently, the demodulating performance measuring apparatus 100 puts the results together and outputs the results as a file or a graph through the output unit 106, or stores the results in an internal memory (not shown).

FIG. 2 is a block diagram showing a demodulating performance measuring system in accordance with an embodiment of the present invention.

In accordance with an embodiment of the present invention, each of the demodulating performance measuring apparatus 100, the mobile station 110 and the central station 120 is connected through Internet networks. The demodulating performance measuring apparatus 100 can perform communication of transmitting a message to the mobile station 110 and the central station 120 through the Internet network and receiving a statistic result. The demodulating performance is measurable by connecting the demodulating performance measuring apparatus 100 in Internet usable places with no regard to the mobile station 110 or the central station 120 by using the Internet network.

The mobile station 110 and the central station 120 are connected through a Radio Frequency (RF) cable. A user connected to the mobile station 110 receives a service supported by a satellite communication system by accessing to the central station 120 through a log-on procedure. In a state that modules forming the mobile station 110 and modules forming the central station 120 are in operation, the user accesses and measures the demodulating performance by transmitting test pattern data based on traffic burst.

Connection between the mobile station 110 and the central station 120 is a link and can be maintained by periodically using synchronization burst. At this time, a forward link is communicating with the mobile station 110 through a satellite in the central station 120 and a return link is communicating with the central station 120 through a satellite in the mobile station 110. The present invention shows an example that the demodulating performance of the central station 120 is measured in a state where the modulator of the mobile station 110 and the demodulator of the central station 120 are connected through the return link. However, it is apparent to those skilled in the art related to the present invention that it is also possible to measure the demodulating performance of the mobile station 110 in communication between the modulator of the central station 120 and the demodulator of the mobile station 110 in a state that the forward link is connected.

A parameter for creating traffic burst and test pattern data can be set up in the demodulating performance measuring apparatus 100. The test pattern data are pre-stored in the mobile station 110 and the central station 120, or may be transmitted from the demodulating performance measuring apparatus 100 in advance.

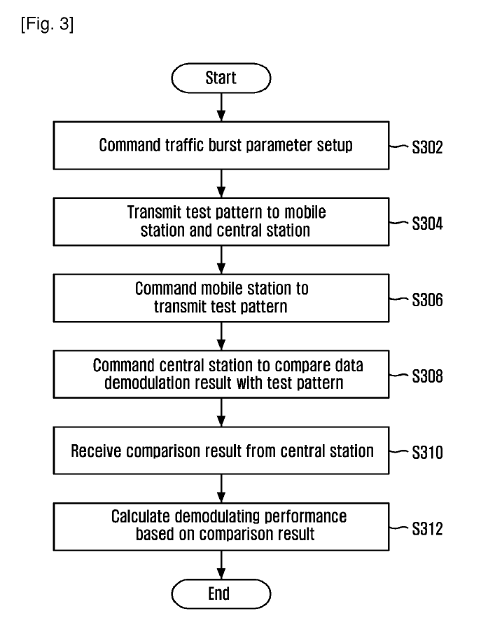

FIG. 3 is a flowchart describing a demodulating performance measuring method in accordance with an embodiment of the present invention.

It is commanded at step S302 for the mobile station 110 to set up a parameter for creating traffic burst or to transmit test pattern data to the mobile station 110 and the central station 120 at step S304.

It is commanded at step S306 for the mobile station 110 to modulate and transmit the test pattern data to the central station 120 in order to measure demodulating performance of the central station 120 in a communication system in a state that a link is connected between the mobile station 110 having a modulator and the central station 120 having a demodulator.

It is commanded at step S308 for the central station 120 to compare a demodulation result of the data transmitted from the mobile station 110 with the test pattern data. Subsequently, the comparison result is transmitted from the central station 120 at step S310.

Since a comparison result is transmitted from the central station 120 in a statistic data format, the demodulating performance is to be calculated based on the statistic data in order to be shown in a format of the bit error rate or the frame error rate. Accordingly, the demodulating performance of the communication system is calculated at step S312 through the comparison result transmitted from the central station 120. At this time, it is general that the demodulating performance measuring apparatus 100 calculates the demodulating performance. However, it is also possible that the central station 120 performs the calculation. In this case, the bit error rate or the frame error rate pre-calculated in the comparison result of the step S310 may be included.

A data structure of the demodulating performance measuring apparatus 100 in accordance with an embodiment of the present invention will be described with reference to Tables 1 to 3 hereinafter.

Table 1 is a data structure of a parameter for traffic burst control.

TABLE 1

typedef struct {unsigned int mode;unsigned int pid;unsigned int
vpi;unsigned int vci;unsigned int pt4;unsigned int burstLen;unsigned
int testCount;unsigned int ttmAddr;unsigned int rldAddr;}
TESTPARAM;

In Table 1, MPEG or ATM is selected as a variable for determining a traffic transmission mode. pid represents TS PID of traffic burst; burstLen represents a size of burst data; and testCount represents an index for unit test. ttmAddr stores an IP address of the modulator 112 of the mobile station and rldAddr stores an IP address of the demodulator 122 of the central station.

Table 2 is a data structure for managing a result that data demodulated after being transmitted through the traffic burst are compared with original test pattern data as statistic information.

TABLE 2

typedef struct{ unsigned int correctFrames; unsigned int
errorFrames; unsigned int correctBits; unsigned int
errorBits;} STATISTICS;

In Table 2, correctFrames stores the number of the same frames when the demodulated data are compared with the original test pattern data. errorFrames stores the number of the frames which are not the same. correctBits stores the number of the same bits when the demodulated data are compared with the original test pattern data. errorBits stores the number of the bits which are not the same.

Table 3 is a data structure of a message for measurement procedure control of the demodulating performance measuring apparatus 100, the modulator 112 of the mobile station, and the demodulator 122 of the central station. Table 3 shows a format of a message transmitted/received among the demodulating performance measuring apparatus 100, the modulator 112 of the mobile station, the demodulating performance measuring apparatus 100, and the demodulator 122 of the central station.

TABLE 3
typedef struct{ unsigned int command; union { TESTPARAM param;
STATISTICS statistics; }u;} MONMSG;

In Table 3, SETPARAM, START, GETRESULT, and RETREIVERESULT are used as the kinds of command messages for command. SETPARAM is used to transmit a parameter for measurement setup before the demodulating performance measuring apparatus 100 commands the modulator 112 of the mobile station to start measurement. START is a message notifying that the modulator 112 of the mobile station is to perform traffic burst. GETRESULT is used for the demodulating performance measuring apparatus 100 to request a comparison statistic result to the demodulator 122 of the central station when the modulator 112 of the mobile station finishes unit measurement on traffic burst. RETREIVERESULT is used for the demodulating performance measuring apparatus 100 to request information to the demodulator 122 of the central station after receiving GETRESULT notifying test end from the modulator 112 of the mobile station.

The param, which is an internal data structure, and statistics have different meanings according to command values. For example, the demodulating performance measuring apparatus 100 transmits the param to the modulator 112 of the mobile station when the command is SETPARAM, and the demodulator 122 of the central station transmits statistics to the demodulating performance measuring apparatus 100 when the command is GETRESULT. The param is a variable for providing information required for creating burst traffic to the modulator 112 of the mobile station. The statistics are used to transmit the comparison statistic result that the demodulator 122 of the central station transmits to the demodulating performance measuring apparatus 100.

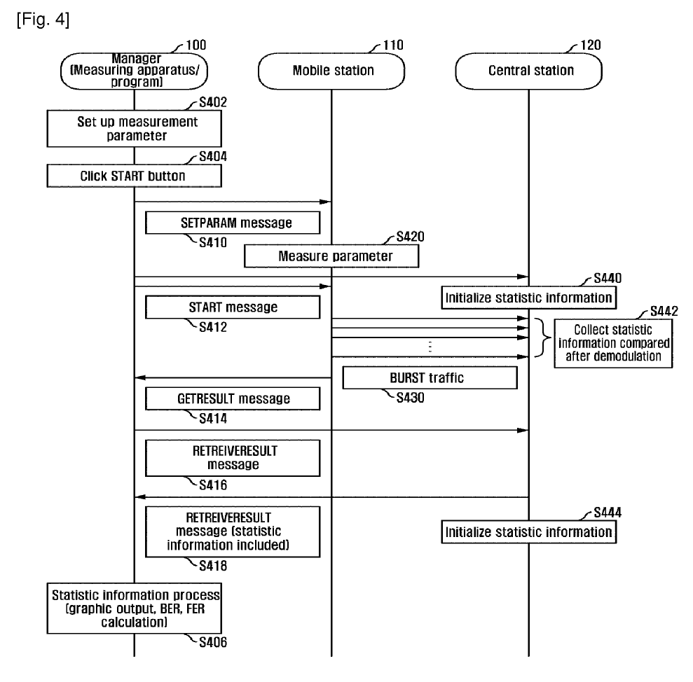

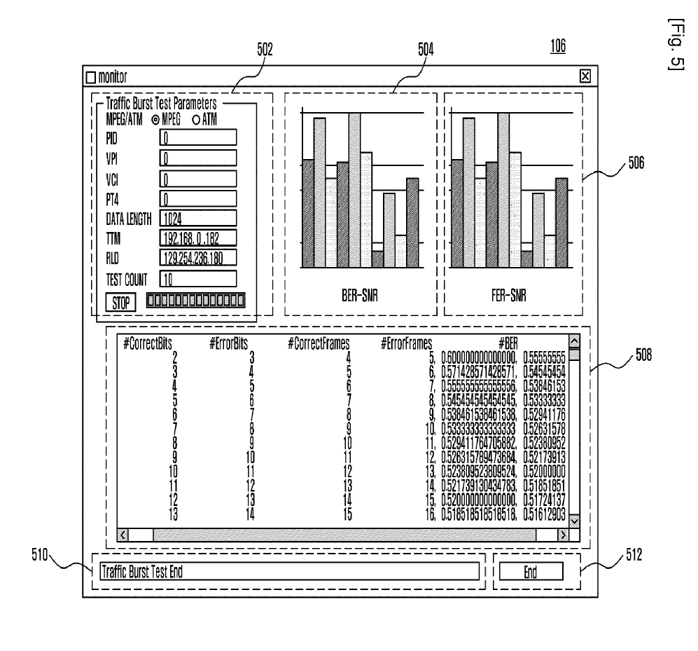

FIG. 4 is a flowchart describing a demodulating performance measuring operation in accordance with an embodiment of the present invention.

The user sets up a parameter for measurement at step S402 before starting measurement in the demodulating performance measuring apparatus 100. This procedure is performed in a block 502 of FIG. 5 below.

When the user commands measurement start at step S404, the set up parameter is transmitted to the mobile station 110 in a SETPARAM message format at step S410 and the central station 120 sets up a measurement parameter at step S420. Also, the start command of the step S404 transmits a START message to the mobile station 110 and the central station 120 at step S412. Accordingly, the mobile station 110 creates BURST traffic based on a pre-set up parameter at step S430 and starts to transmit test pattern data. At step S440, the central station 120 initializes statistic information for storing comparison data. When the START message is transmitted to the mobile station 110 at the step S412 and the mobile station 110 transmits the BURST traffic created in the step S430, the central station 120 compares the demodulating and decoding result with the originally transmitted data and collects the number of right bits and wrong bits at step S442.

When the mobile station 110 transmits data as much as the numbers determined in the measurement parameter setting step S402, a GETRESULT message is transmitted to the demodulating performance measuring apparatus 100 at step S414. Accordingly, the demodulating performance measuring apparatus 100 transmits a RETREIVERESULT message to the central station 120 at step S416 and receives a result including statistic information in a RETREIVERESULT message format at step S418.

The central station 120 initializes statistic information at step S444 and processes the statistic information in the demodulating performance measuring apparatus 100 at step S406.

FIG. 5 shows Graphic User Interface (GUI) of the demodulating performance measuring apparatus 100 realized as a program as an example of the demodulating performance measuring apparatus output unit 106 in accordance with an embodiment of the present invention.

The block 502 is a part for setting up a parameter required for performing traffic burst. The user starts a test by clicking the START button at the step S404 after setting up the parameter according to the object of the test. TEST COUNT means the number of unit tests.

Blocks 504 and 506 are parts showing a bit error rate and a frame error rate, which are outputted based on the statistic data that the demodulating performance measuring apparatus 100 receives from the demodulator 122 of the central station, as a graph.

A block 508 is a part displaying the received statistic data. The statistic data include the bit error rate and the frame error rate with correctBits, errorBits, correctFrames, and errorFrames described in the data structure. A block 510 is a part that the demodulating performance measuring apparatus 100 notifies information on a current state to the user while performing a measuring procedure. When the measuring procedure ends, the user ends the program through an end button 512.

As described above, the technology of the present invention can be realized as a program. A code and a code segment forming the program can be easily inferred from a computer programmer of the related field. Also, the realized program is stored in a computer-readable recording medium, i.e., information storing media, and is read and operated by the computer, thereby realizing the method of the present invention. The recording medium includes all types of recording media which can be read by the computer.

The present application contains subject matter related to Korean Patent Application Nos. 2007-0128378 and 2008-0014783, filed in the Korean Intellectual Property Office on Dec. 11, 2007 and Feb. 19, 2008, the entire contents of which are incorporated herein by reference.

While the present invention has been described with respect to certain preferred embodiments, it will be apparent to those skilled in the art that various changes and modifications may be made without departing from the scope of the invention as defined in the following claims.

1. A method for measuring demodulating performance in a communication system of a state that a link is connected between a mobile station having a modulator and a central station having a demodulator, comprising:
commanding the mobile station to modulate test pattern data and transmit test pattern data to the central station;
commanding the central station to comparing a demodulation result of the data transmitted from the mobile station with the test pattern data; and
receiving the comparison result from the central station.

2. The method of claim 1, wherein said commanding the mobile station, said commanding the central station and said receiving the comparison result are performed through an Internet network.

3. The method of claim 1, wherein data are transmitted from the mobile station to the central station through traffic burst.

4. The method of claim 3, further comprising:
commanding the mobile station to set up a parameter for creating the traffic burst.

5. The method of claim 1, further comprising:
transmitting the test pattern data to the mobile station and the central station.

6. The method of claim 1, further comprising:
calculating demodulating performance of the communication system based on the comparison result transmitted from the central station.

7. The method of claim 6, wherein calculation of the demodulating performance is outputted as any one of a bit error rate (BER) and a frame error rate (FER).

8. An apparatus for measuring demodulating performance in a communication system of a state that a link is connected between a mobile station having a modulator and a central station having a demodulator, comprising:
a communication unit for communicating with the mobile station and the central station; and
a control unit for controlling the mobile station to modulate and transmit test pattern data to the central station, controlling the central station to compare a demodulation result of the data transmitted from the mobile station with the test pattern data, and controlling the communication unit to receive the comparison result from the central station.

9. The apparatus of claim 8, wherein the communication unit communicates with the mobile station and the central station through an Internet network.

10. The apparatus of claim 8, wherein data are transmitted from the mobile station to the central station through traffic burst.

11. The apparatus of claim 10, wherein the control unit controls the mobile station to set up a parameter for creating the traffic burst.

12. The apparatus of claim 8, wherein the control unit calculates demodulating performance of the communication system based on the comparison result transmitted from the central station.

13. The apparatus of claim 12, wherein calculation of the demodulating performance is outputted as any one of a bit error rate (BER) and a frame error rate (FER).

14. The apparatus of claim 12, further comprising:
an output unit for displaying at least one of the calculation results of the demodulating performance in the comparison result.

15. A computer readable recording medium for recording a program for performing a method of measuring demodulating performance in a communication system in a state that a link is connected between a mobile station having a modulator and a central station having a demodulator, the program, comprising:
commanding the mobile station to modulate and transmit test pattern data to the central station; and
commanding the central station to compare the demodulation result of the data transmitted from the mobile station with the test pattern data.
